(19) United States
(12) Patent Application Publication
(10) Pub. No.: US 2019/0018554 A1
(43) Pub. Date: Jan. 17, 2019

(54) VIRTUAL REALITY SYSTEM AND PROCESS FOR REMOTE INTERACTION WITH A PERFORMANCE EVENT

(71) Applicant: AD-AIR GROUP LLC, Newport News, VA (US)

(72) Inventor: ROBERT FITZGERALD, Williamsburg, VA (US)

(21) Appl. No.: 16/050,859

(22) Filed: Jul. 31, 2018

Related U.S. Application Data
(60) Provisional application No. 62/513,970, filed on Jun. 1, 2017.

(51) Int. Cl. G06F 3/0482; H04N 13/117; H04N 13/361; H04N 13/398; G06Q 30/06

(52) U.S. Cl. CPC G06F 3/0482; H04N 13/117; H04N 5/23238; H04N 13/398; G06Q 30/0641; H04N 13/361

(57) ABSTRACT

A virtual reality (VR) system and process provides immersion into a live or recorded event/performance. While immersed in the VR environment, the user is provided a VR interaction menu. Within the menu, the user may engage a social media function providing access to the user's social media account(s). Interaction with the event through the system may allow the user to post for example, screen captures of the user's perspective within the VR environment to their social media account which is visible while the user remains immersed in the VR environment. Another function may display an online store which allows the user to purchase merchandise while remaining immersed in the VR environment.

### FIELD

The subject disclosure relates to virtual reality systems and more particularly to a system and process for remote interaction with a performance event.

### BACKGROUND

When attending a live performance, (for example a concert, musical festival, etc.) traditionally one attended with a passive presence. More contemporary performances encourage audience interaction to enliven the experience. Some systems connected to a performance allow audience members to experience part of the show through electronic means. With the advent of mobile computing devices, audience members can be taken to web pages or mobile apps related to the show. Apart from the actual show, audience members may connect to other sites unrelated to the show (for example social media pages) to post static photos or vignettes of live video.

Some technology now allows users to experience a performance through virtual reality (VR). The performance may be live or pre-recorded. The user activates VR equipment and the performance is streamed for the personal experience. Thus people may now witness a performance remotely from the actual venue and still feel as though they are part of the scene. However, to post to social media accounts, users have to exit from the VR environment. Conventionally, the user accesses their smart phone and uses a third party app to post information on social media. If the user wishes to purchase merchandise related to the event, the user likewise accesses a separate app or webpage from their smartphone to browse online and make purchases. As may be appreciated, these activities disconnect the user as an audience member and distracts them from the experience of the event.

As can be seen, there is a need for a system and process that can provide users with access to social media and merchandising without removing them from the event experience.

### SUMMARY

In one aspect of the disclosure, a virtual reality (VR) system for user interaction of a VR event comprises a VR enabled user device for displaying a VR environment of a performance. A host computer server manages transmission of the VR environment of the performance to the VR enabled user device. A software module running on either the VR enabled user device, the host server, or both, the software module is configured to: display to a user, the VR environment of the performance, display an interactive VR menu of functions overlaying the VR environment of the performance, display a first user interface of the user's social media account(s) in response to the user triggering one of the interactive VR menu of functions while the user remains immersed in the VR environment of the performance, wherein the display of the first user interface of the user's social media account(s) is enabled for posting screen captures of the VR environment of the performance, and display a second user interface of an online store in response to the user triggering a second one of the interactive VR menu of functions, wherein the display of the second user interface of online store is enabled for purchasing merchandise while the user remains immersed in the VR environment of the performance.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

FIG. 1 is a block diagram of a system for providing a virtual reality based performance setting with integrated social media and e-commerce access in accordance with an aspect of the subject technology.

FIG. 2 is a screenshot of a user interface in a mobile computing device for providing a virtual reality based performance venue in accordance with an aspect of the subject technology.

FIGS. 3-5 are screenshots of virtual reality displays of a performance provided by the user interface of FIG. 2 in accordance with an aspect of the subject technology.

FIG. 6 is a screenshot of a social media access user interface provided by selecting a social media icon in the user interface shown in FIGS. 4 and 5.

FIGS. 7 and 8 are screenshots of e-commerce user interfaces activated by triggering an event merchandise function in the user interface shown in FIGS. 4 and 5.

FIG. 9 is a screenshot of a virtual reality display with a social media page integrated into the virtual reality field of view in accordance with an aspect of the subject technology.

FIG. 10 is a block diagram of a computer/server system for providing virtual reality performances with social media and e-commerce access in accordance with an aspect of the subject technology.

FIG. 11 is a block diagram of a network providing and hosting virtual reality performances with social media and e-commerce access in accordance with an aspect of the subject technology.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. Like or similar components are labeled with identical element numbers for ease of understanding.

Generally, embodiments of the subject technology provide a system and process for providing a virtual reality (VR) experience with access to social media and e-commerce integrated into the VR setting. In a software embodiment, the software may run on any mobile computing device and computer. The software provides a user with a virtual reality interface that allows a user to remotely watch a live or recoded event in three dimensional, 360 degree virtual presence, interact in real time with social media, access and purchase merchandise from an online store, interact with augmented reality objects and navigate to different camera locations in the performance. In an exemplary embodiment, the user may don a head mounted display (HMD). The HMD may be a standalone device or an accessory attached to a mobile computing device such as a smart phone. The user can stay in the VR environment and does not need to remove the HMD or even disengage from the VR performance to post on social media and/or make purchases on an online store.

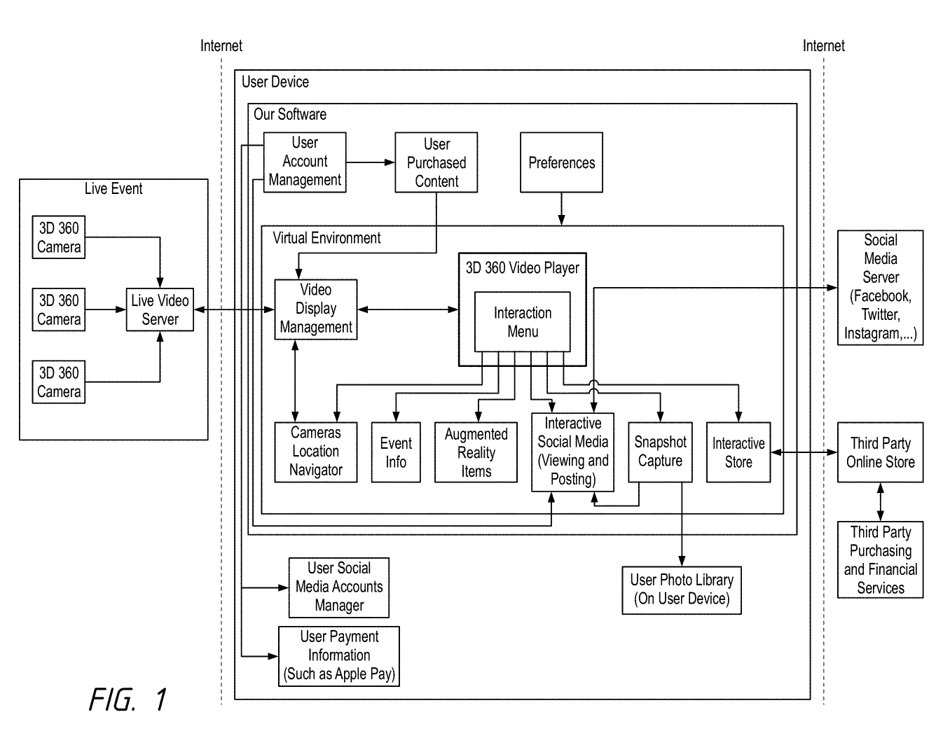

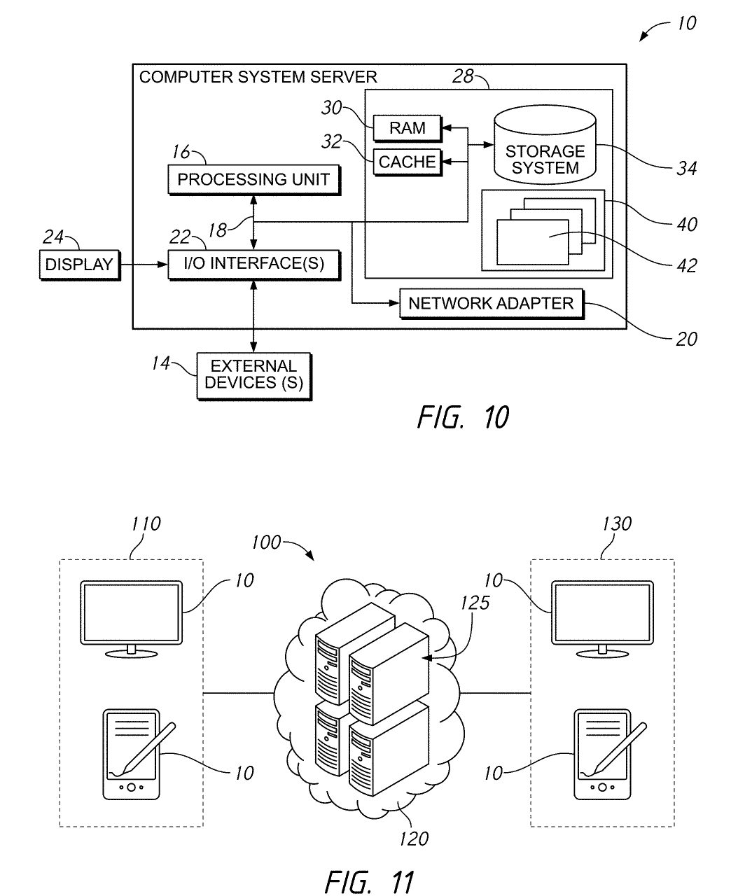

Referring now to FIG. 1, a system is shown according to an exemplary embodiment. The system includes a user device which may be a mobile computing device (described in more detail below with respect to FIG. 10). In an exemplary embodiment, the user device is a head mounted display configured to project a VR environment of the performance so that the user sees and feels as they are attending the performance in-person. The user device also includes a software module (pre-loaded or downloaded) for accessing a VR feed of the live/recorded event and converting the feed source into the VR environment experience by the user. In an exemplary embodiment, a wireless connection (for example, Internet, cellular, Wi-Fi, etc.) may transmit the feed from a live video server coordinating/storing video footage of the event from a plurality of 3D 360 degree cameras positioned throughout the event venue capturing the performance, scenery, special effects, and attendees from multiple angles and points of view. A VR player module processes the live/recorded performance data and transforms the data for user viewing. The player module includes an interaction menu which allows the user to switch camera locations/points of view, access event information, interact with displayed augmented reality items, and in an exemplary embodiment, interact with their social media account(s) and/or an interactive merchandise store while immersed in the VR environment.

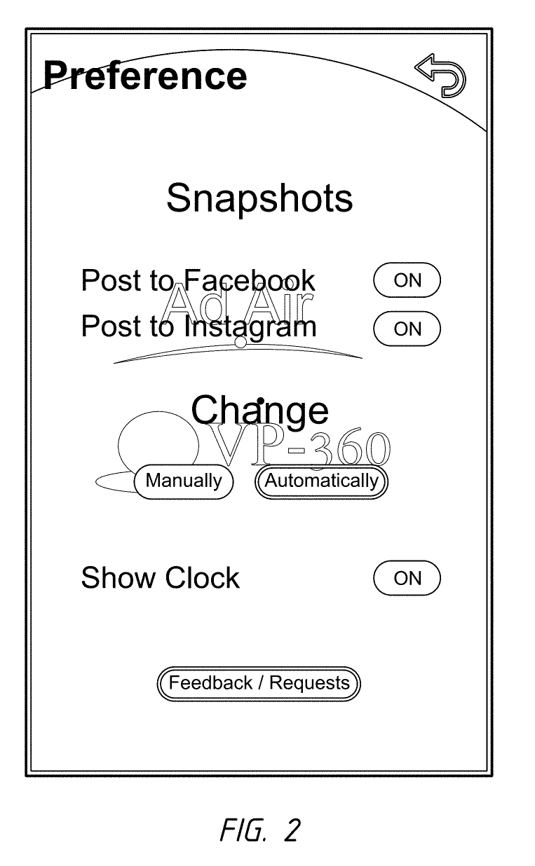

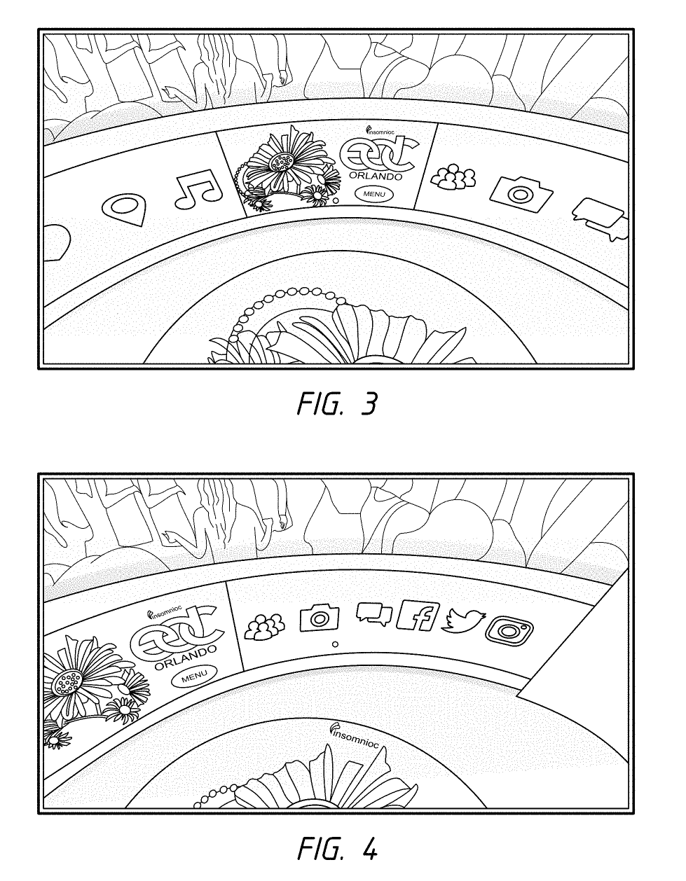

Referring now to FIGS. 2-9 concurrently with FIG. 1, screenshots showing a user interacting with aspects of the system while immersed in a VR environment of a performance are shown according to an exemplary embodiment. When seeking to attend a VR feed of a performance, the user may access a software embodiment through an app user interface (FIG. 2) loaded onto the user device. An initial two-dimensional screen may be shown where the user selects an event of other app functions. Once in the VR environment, a heads up display (or pop-up window) may be presented to the user (FIGS. 3 and 4) which shows an interactive menu of functions floating over (a window overlay) the VR environment. To trigger a menu function, the system, in an exemplary embodiment, may include an eye position/gaze detector. To trigger a desired function, the user may, focus on a virtual menu button/symbol for a pre-determined time (for example, ½ seconds). As is shown, for example, the user may be immersed so that he or she appears to be a member of the audience and is surrounded by live attendees. The display of an interaction menu is floating in front of the surrounding audience members from a first person perspective.

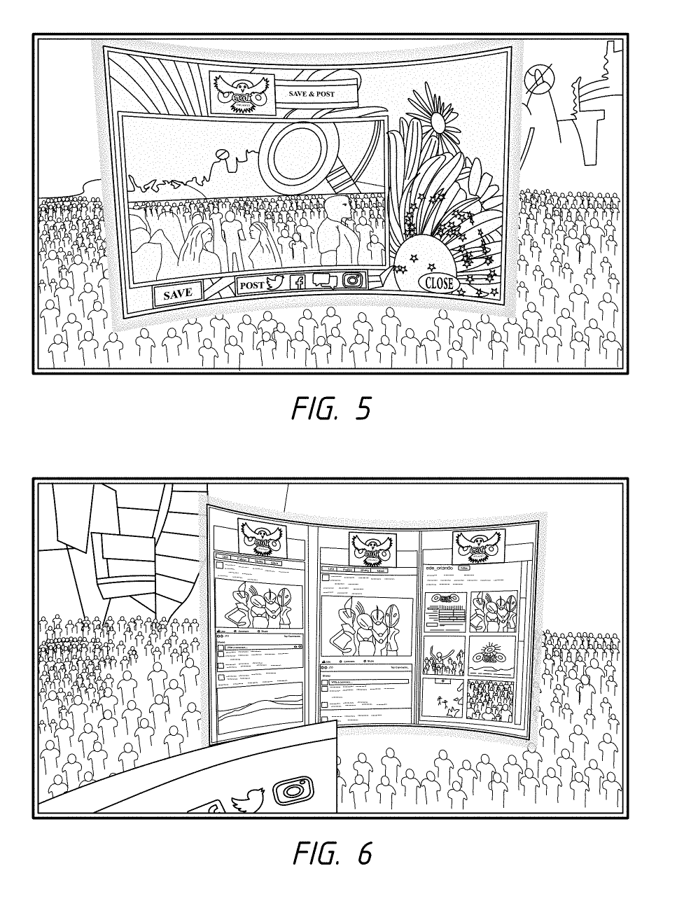

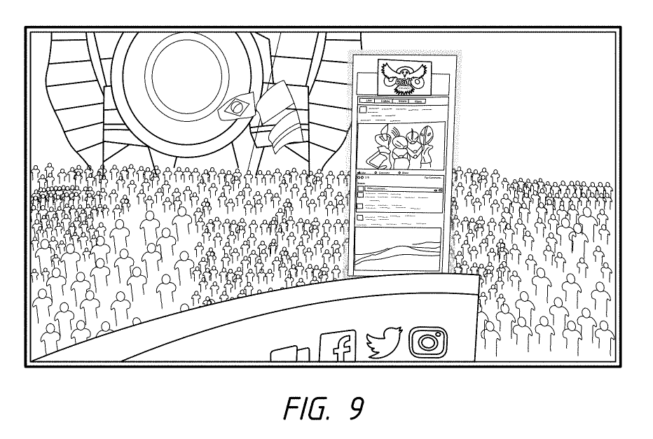

FIG. 5 shows another window which may overlay the VR audience scene. The window shows an alternate camera position and/or is a screen capture of the VR scene taken by the user (whether from the user's current perspective or another camera perspective). While still immersed in the VR environment, the user may be presented with a function to save and post the screen capture to a social media account linked to the app. A user social media accounts manager module may access one or more of the user's accounts through a network connection. FIGS. 6 and 9 show pop-up windows overlaying the VR environment displaying pages from the user's social media account(s). The user may engage their social media page with all the functions one would normally enjoy for example, typing in text, selecting a pre-defined flagging symbol (for example, a “like”, “thumbs up/down”, etc.), video play, etc. through a VR GUI mechanism (virtual cursor, virtual keyboard, etc.). The user may post the screen capture from the event while still immersed in the VR environment and may access their page to see the post and any received comments. In addition, the user may see other's posts which may be related to the attended event.

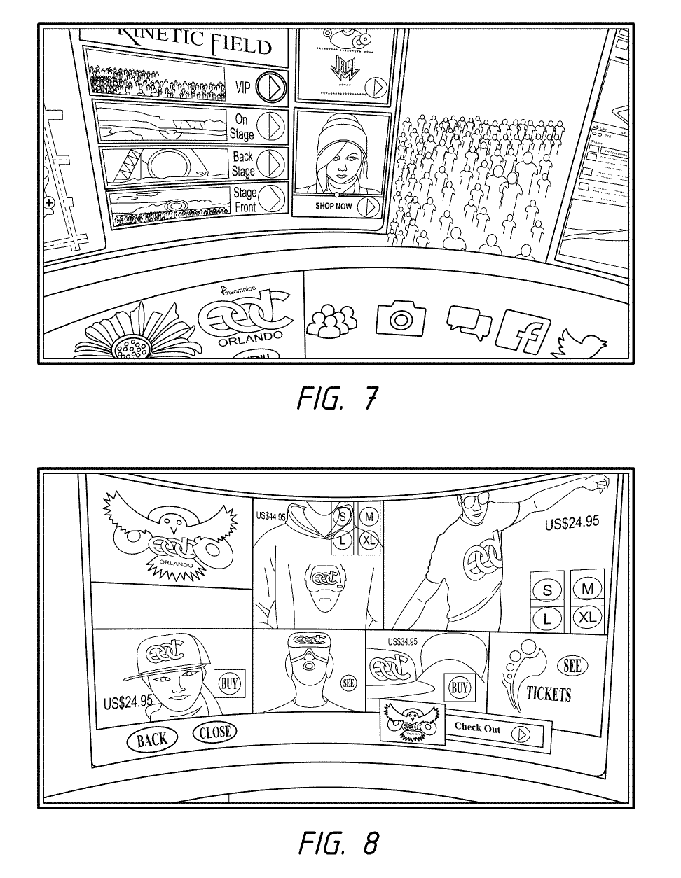

Another exemplary function related to an e-commerce function may be presented to the user while still immersed in the VR environment. The user may access an online store selling merchandise related to for example, the event, artist, etc. from the user interaction menu. The user can access a store page by gazing at specific buttons. FIG. 7 shows for example, a “Shop Now” button within an exemplary user interface. In response, a VR store page (FIG. 8) then appears overlaid the VR environment and displays the available items for purchase. On the store page, the user can select items for purchase by gazing at them and adding them to their check-out cart. To implement the checkout, users may have two options:

Option 1, the user can do a VR checkout, if he/she elected to link for example PayPal or any other third party financial services from a user preferences file (see FIG. 1), or

Option 2: do a checkout in standard 2D mode after the user ends the VR mode, this checkout would be similar to any other online purchasing store (using a third party financial service.

Referring now to FIG. 10, a schematic of an example of a computer system/server 10 is shown. The computer system/server 10 is shown in the form of a general-purpose computing device. As may be appreciated, reference to a computer system/server 10 (sometimes referred to as a “general computing machine” or “mobile computing device”) in the following description may refer to different machines depending on the role or function being performed. In addition, more than one computer system/server 10 may be present simultaneously in embodiments, for example in the network 100 described more fully below. The computer system/server 10 may serve the role as the machine implementing for example functions related to the user device described above which may include for example, displaying a VR environment to the user, displaying VR menus, VR menu functions, VR user interfaces, and coordination with third party accounts/apps. The computer system/server 10 may also represent the role as the machine implementing for example, a host server and platform implementing storing and managing of user accounts to a subscription based service accessing aspects of the disclosed system, managing transmission of live/recorded events, processing user triggered functions related to an attended event, coordinating services between the user and third party apps/services (for example social media and financial service providers), and managing download/access to aspects of the system. The components of the computer system/server 10 may include, but are not limited to, one or more processors or processing units 16, a system memory 28, and a bus 18 that couples various system components including the system memory 28 to the processor 16.

The computer system/server 10 may be for example, personal computer systems, tablet devices, mobile/smart telephone devices, programmable consumer electronics (including for example, stand-alone VR display systems), wearable smart devices (for example, smart glasses, watches/bracelets/other jewelry, etc.), server computer systems, handheld or laptop devices, multiprocessor systems, microprocessor-based systems, set top boxes, network PCs, and distributed cloud computing environments that include any of the above systems or devices, and the like.

The computer system/server 10 may be described in the general context of computer system executable instructions, such as program modules, being executed by a computer system. In some embodiments, the computer system/server 10 may be a cloud computing node connected to a cloud computing network (not shown). The computer system/server 10 may be practiced in distributed cloud computing environments where tasks are performed by remote processing devices that are linked through a communications network. In a distributed cloud computing environment, program modules may be located in both local and remote computer system storage media including memory storage devices.

The computer system/server 10 may typically include a variety of computer system readable media. Such media could be chosen from any available media that is accessible by the computer system/server 10, including non-transitory, volatile and non-volatile media, removable and non-removable media. The system memory 28 could include one or more computer system readable media in the form of volatile memory, such as a random access memory (RAM) 30 and/or a cache memory 32. By way of example only, a storage system 34 can be provided for reading from and writing to a non-removable, non-volatile magnetic media device. The system memory 28 may include at least one program product 40 having a set (e.g., at least one) of program modules 42 that are configured to carry out the functions of embodiments of the invention. The program product/utility 40, having a set (at least one) of program modules 42, may be stored in the system memory 28 by way of example, and not limitation, as well as an operating system, one or more application programs, other program modules, and program data. Each of the operating system, one or more application programs, other program modules, and program data or some combination thereof, may include an implementation of a networking environment. The program modules 42 generally carry out the functions and/or methodologies of embodiments of the invention as described above.

The computer system/server 10 may also communicate with one or more external devices 14 such as a keyboard, a pointing device, a display 24, etc.; and/or any devices (e.g., network card, modem, etc.) that enable the computer system/server 10 to communicate with one or more other computing devices. Such communication can occur via Input/Output (I/O) interfaces 22. Alternatively, the computer system/server 10 can communicate with one or more networks such as a local area network (LAN), a general wide area network (WAN), and/or a public network (e.g., the Internet) via a network adapter 20. As depicted, the network adapter 20 may communicate with the other components of the computer system/server 10 via the bus 18.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Any combination of one or more computer readable media (for example, storage system 34) may be utilized. In the context of this disclosure, a computer readable storage medium may be any tangible or non-transitory medium that can contain, or store a program (for example, the program product 40) for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing.

Aspects of the disclosed invention are described below with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor 16 of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The system 100 generally includes a first party 110, a second party 130, and a network 120. The first and second parties 110; 130 may represent for example the event video server and the end-user wearing a VR enabled device. The network 120 may include a server(s) 125 storing a software embodiment of the disclosed invention and acting as an intermediary or host providing the management of the system including feeds of a performance to the end-user 130. The first party 110 and second party 130 may interact with the system 100 through respective general computing machines 10. The server(s) 125 likewise may function for example, under the description of the general computing machine 10. In the event the end-user 130 attends a live performance through the system, the host server 125 provides the live feed from the first party 110, processes the data, and re-transmits the performance feed for view and interaction to the end-user 130. In the event the end-user selects a recorded performance, the feed comes directly pre-processed from the server 125 to the end-user 130. Should the end-user 130 interact with menu functions related to third parties during a recorded event, the functionality remains intact as if the user were at a live event and social media posts or online purchases remain intact.

Those of skill in the art would appreciate that various components and blocks may be arranged differently (e.g., arranged in a different order, or partitioned in a different way) all without departing from the scope of the subject technology.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. For example, while the foregoing was described in the context of a rewards or redemption program and associated liabilities, it will be understood that other applications may use aspects of the subject technology to track information and assess changing value as provided by the system and processes disclosed.

Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A virtual reality (VR) system for user interaction of a VR event, comprising:
a VR enabled user device for displaying a VR environment of a performance;
a host computer server managing transmission of the VR environment of the performance to the VR enabled user device;
a software module running on either the VR enabled user device, the host server, or both, the software module configured to:
display to a user, the VR environment of the performance,
display an interactive VR menu of functions overlaying the VR environment of the performance,
display a first user interface of the user's social media account(s) in response to the user triggering one of the interactive VR menu of functions while the user remains immersed in the VR environment of the performance, wherein the display of the first user interface of the user's social media account(s) is enabled for posting screen captures of the VR environment of the performance, and
display a second user interface of an online store in response to the user triggering a second one of the interactive VR menu of functions, wherein the display of the second user interface of online store is enabled for purchasing merchandise while the user remains immersed in the VR environment of the performance.
